(19) United States
(12) Patent Application Publication
(10) Pub. No.: US 2026/0058150 A1
(43) Pub. Date: Feb. 26, 2026

(54) LITHIUM METAL ANODE AND LITHIUM SECONDARY BATTERY INCLUDING THE SAME

(71) Applicants: Hyundai Motor Company, Seoul (KR); Kia Corporation, Seoul (KR)

(72) Inventors: Jae Wook Shin, Hwaseong (KR); Won Keun Kim, Hwaseong (KR); Seongmin Ha, Hwaseong (KR); Seungjong Lee, Hwaseong (KR); Kyoung Han Ryu, Hwaseong (KR); Jongchan Song, Hwaseong (KR)

(21) Appl. No.: 19/235,372

(22) Filed: Jun. 11, 2025

(30) Foreign Application Priority Data
Aug. 20, 2024 (KR) 10-2024-0111028

(51) Int. Cl. H01M 4/62; H01M 4/02; H01M 4/36; H01M 4/38; H01M 10/052

(52) U.S. Cl. CPC H01M 4/622; H01M 4/366; H01M 4/382; H01M 4/626; H01M 10/052; H01M 2004/021; H01M 2004/027

(57) ABSTRACT

Provided is a lithium metal anode and a lithium secondary battery including the same. The lithium metal anode includes a lithium metal layer arranged on a current collector, and a protective layer arranged on the lithium metal layer, in which the protective layer includes a polymer binder and lithium conductive particles, and the polymer binder is nonpolar. The polymer binder may not comprise fluorine (F). A lithium electrodeposition layer in the lithium metal layer may have a thickness of about 15 μm or greater. A weight ratio of the lithium conductive particles to the polymer binder (lithium conductive particles (wt %)/polymer binder (wt %)) may be about 2.0 to 10.0.

### CROSS-REFERENCE TO RELATED APPLICATION

This application claims under 35 U.S.C. § 119(a) the benefit of Korean Patent Application No. 10-2024-0111028 filed in the Korean Intellectual Property Office on Aug. 20, 2024, the entire contents of which are incorporated herein by reference.

### BACKGROUND

### Technical Field

The present disclosure relates to a lithium secondary battery, and more specifically, to a lithium metal anode and a lithium secondary battery including the same.

### BACKGROUND

Batteries are energy storage sources capable of converting chemical energy into electrical energy or electrical energy into chemical energy. Batteries can be divided into non-reusable primary batteries and reusable secondary batteries. Compared to primary batteries that are used once and discarded, secondary batteries have the advantage of being more environmentally friendly because they can be reused.

Recently, as environmental concerns have grown, the demand for hybrid electric vehicle (HEV) and electric vehicle (EV) with little or no air pollution has been increasing. In particular, EVs are vehicles on which no internal combustion engine is mounted, suggesting the direction the world is headed in the future.

A lithium secondary battery is used as an energy source for many EVs. A lithium secondary battery is largely composed of a positive electrode, a negative electrode, an electrolyte, and a separator. In the positive electrode and the negative electrode, intercalation and deintercalation of lithium ions are repeated to generate energy, the electrolyte becomes a path for lithium ion migration, and the separator serves to prevent contact between the positive electrode and the negative electrode, thereby avoiding a short circuit in the battery.

Specifically, the positive electrode is closely related to the capacity of the battery, while the negative electrode is closely related to the performance of the battery, such as high-speed charging and discharging. The electrolyte is composed of a solvent, an additive, and a lithium salt. The solvent becomes a migration channel that helps lithium ions migrate between the positive electrode and the negative electrode. For a battery to have good performance, lithium ions must be rapidly transferred between the positive electrode and the negative electrode.

Incidentally, lithium metal has excellent theoretical capacity of 3,860 mAh/g and has very low standard reduction potential (Standard Hydrogen Electrode; SHE) of −3.045 V, enabling a battery with high capacity and high energy density. Consequently, various studies on lithium metal anodes using lithium metal as a negative electrode active material of a lithium secondary battery have been conducted.

However, since the lithium metal anode has a low reduction potential and undergoes a large volume change, the solid electrolyte interphase (SEI), which is a lithium-electrolyte film, does not easily form, leading to continuous, unstable decomposition of the electrolyte. In addition, there is a problem in that the electrolyte can become depeleted at the negative electrode to cause a reduction in cell life or a reaction between the lithium metal anode and the electrolyte exhausts the negative electrode to reduce the cell life.

To address these challenges, various studies are being conducted on placing a protective layer on a surface of the lithium metal anode, which reacts with the electrolyte to prevent the decomposition of the electrolyte.

However, the conventional protective layer placed on the surface of the lithium metal anode has problems with reactivity with lithium. In addition, when lithium is electrodeposited on the lithium metal anode, there is a problem in that the protective layer is torn or damaged due to non-uniformity, causing the electrolyte to flow into the lithium metal anode through the protective layer. This increases the resistance of the negative electrode and decreases the charge/discharge efficiency of the battery.

### SUMMARY

The technical problem to be solved by the some embodiments of the present disclosure is to provide a lithium metal anode with improved life characteristics by minimizing reactivity with lithium and preventing an electrolyte from flowing into a lithium metal layer even when lithium is non-uniformly electrodeposited inside or on a surface of the lithium metal layer.

Another technical problem to be solved by some embodiments of the present disclosure is to provide a lithium secondary battery including a lithium metal anode with the aforementioned advantages.

Still another technical problem to be solved by some embodiments of the present disclosure is to provide a method for manufacturing a lithium metal anode with the aforementioned advantages.

According to some embodiments of the present disclosure, a lithium metal anode includes a lithium metal layer arranged on a current collector, and a protective layer arranged on the lithium metal layer, in which the protective layer includes a polymer binder and lithium conductive particles, and the polymer binder is nonpolar. In some embodiments, a weight ratio of the lithium conductive particles to the polymer binder (lithium conductive particles (wt %)/polymer binder (wt %)) may be 2.0 to 10.0.

In some embodiments, a thickness of the protective layer may be 10 to 20 μm. In some embodiments, an average particle diameter (D50) of the lithium conductive particles may be from 100 to 850 nm. In some embodiments, the polymer binder may be a high-elasticity polymer.

In some embodiments, the polymer binder may not contain fluorine (F). In some embodiments, the polymer binder may include at least one of a styrene-based polymer, a block co-polymer, a polyolefin-based polymer, a polyurethane-based polymer, and a silica-based polymer.

In some embodiments, the lithium conductive particles may include at least one of a lithium-based oxide, a nitride, a sulfide, a fluoride, a phosphide, and a solid electrolyte material. In some embodiments, the protective layer may include a solvent, and the solvent may include 30 to 50 wt % of solid content based on 100 wt % of the protective layer.

In some embodiments, the solvent may include at least one of benzene, toluene, xylene, and an alkane-based material. In some embodiments, the protective layer may further include a dispersant, and the dispersant may be included in an amount of 3 wt % or less based on 100 wt % of the protective layer.

In some embodiments, the lithium conductive particles may include a doping material, and the doping material may be a Nb-based material. In some embodiments, a packing density of the polymer binder and the lithium conductive particles in the protective layer may be 30 to 50 wt % of solid content based on 100 wt % of the protective layer.

In some embodiments, the lithium conductive particles may include fine particles and coarse particles with an average particle diameter larger than that of the fine particles, and a weight ratio of the fine particles to the coarse particles (fine particles (wt %):coarse particles (wt %)) may be 0.5:9.5 to 3.0:7.0.

In some embodiments, the lithium metal anode may further include a lithium electrodeposition layer in the lithium metal layer, and a thickness of the lithium electrodeposition layer may be 5 to 15 μm. In some embodiments, the lithium metal layer may further include an initial lithium layer and a lithium electrodeposition layer arranged on the initial lithium layer, and an average thickness ratio of the initial lithium layer to the lithium electrodeposition layer (initial lithium layer: lithium electrodeposition layer) may be 5:5 to 20:20.

According to some embodiments of the present disclosure, a lithium secondary battery may include the lithium metal anode described above.

According to some embodiments of the present disclosure, a lithium metal anode includes a protective layer arranged on a lithium metal layer and including a nonpolar polymer binder and lithium conductive particles, thereby minimizing reactivity with lithium and preventing electrolyte from flowing into the lithium metal layer even when lithium is non-uniformly electrodeposited inside or on a surface of the lithium metal layer, resulting in improved life characteristics of the negative electrode.

According to some embodiments of the present disclosure, a lithium secondary battery includes a lithium metal anode with the aforementioned advantages, thereby providing improved life characteristics of the battery.

As discussed, the method and system suitably include use of a controller or processer.

In some embodiments, vehicles are provided that comprise an apparatus as disclosed herein.

### BRIEF DESCRIPTION OF THE DRAWINGS

FIG. 1 is a schematic view of a lithium metal anode according to some embodiments of the present disclosure;

FIG. 2 is a plan view of a lithium metal anode according to an Example of the present disclosure;

FIG. 3 is a plan view of a lithium metal anode according to a Comparative Example;

FIG. 4 is a cross-sectional view of a lithium metal anode according to the Example of the present disclosure;

FIG. 5 is a cross-sectional view of a lithium metal anode according to the Comparative Example;

FIG. 6 is a graph showing life characteristics of a lithium metal anode according to the Example of the present disclosure;

FIG. 7 is a graph showing life characteristics of a lithium metal anode according to the Comparative Example;

FIG. 8 shows a graph of charging voltage versus capacity according to Examples of the present disclosure and Comparative Examples;

FIG. 9 is a plan view showing surfaces of lithium metal anodes after full charging according to Examples of the present disclosure and Comparative Examples;

FIG. 10 shows a graph of capacity versus cycle number according to Examples of the present disclosure and Comparative Examples;

FIG. 11 is a cross-sectional view of a lithium metal anode according to the Example of the present disclosure; and

FIG. 12 is a cross-sectional view of a lithium metal anode according to the Comparative Example.

### DETAILED DESCRIPTION

The terms such as first, second and third are used for describing, but are not limited to, various parts, components, regions, layers, and/or sections. These terms are used only to discriminate one part, component, region, layer or section from another part, component, region, layer or section. Therefore, a first part, component, region, layer or section described below may be referred to as a second part, component, region, layer or section without departing from the scope of the present disclosure.

The technical terms used herein are set forth only to mention specific embodiments and are not intended to limit the present disclosure. Singular forms used herein are intended to include the plural forms as long as phrases do not clearly indicate an opposite meaning. In the present specification, the term “including (comprising)” is intended to embody specific characteristics, regions, integers, steps, operations, elements and/or components, but is not intended to exclude presence or addition of other characteristics, regions, integers, steps, operations, elements, and/or components.

When a part is referred to as being “above” or “on” another part, it may be directly above or on the other part or an intervening part may also be present. In contrast, when a part is referred to as being “directly above”another part, there is no intervening part present.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a,” “an” and “the” are intended to include the plural forms as well, unless the context clearly indicates otherwise. These terms are merely intended to distinguish one component from another component, and the terms do not limit the nature, sequence or order of the constituent components. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. Throughout the specification, unless explicitly described to the contrary, the word “comprise” and variations such as “comprises” or “comprising” will be understood to imply the inclusion of stated elements but not the exclusion of any other elements. In addition, the terms “unit”, “-er”, “-or”, and “module” described in the specification mean units for processing at least one function and operation and can be implemented by hardware components or software components and combinations thereof.

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor and is specifically programmed to execute the processes described herein. The memory is configured to store the modules, and the processor is specifically configured to execute said modules to perform one or more processes which are described further below.

Further, the control logic of the present disclosure may be embodied as non-transitory computer readable media on a computer readable medium containing executable program instructions executed by a processor, controller or the like. Examples of computer readable media include, but are not limited to, ROM, RAM, compact disc (CD)-ROMs, magnetic tapes, floppy disks, flash drives, smart cards and optical data storage devices. The computer readable medium can also be distributed in network coupled computer systems so that the computer readable media is stored and executed in a distributed fashion, e.g., by a telematics server or a Controller Area Network (CAN).

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about”.

The term “lithium metal anode” herein refers to a negative electrode for a lithium-based electrochemical cell.

The term “lithium metal layer” herein refers to a layer formed over configured to protect the lithium metal.

The term “polymer binder” herein refers to a polymeric material within the protective layer that holds or binds other constituents together.

The term “nonpolar polymer binder” herein refers to a polymer binder substantially free of electronegative or strongly polar functional groups. In particular aspects, a nonpolar polymer binder may be at least substantially free of a halogen such as F, B, l and/or I, and particularly F, and/or at least substantially free of a carboxyl (includes carbonyl, ester), amide, cyano, nitro or the like. A nonpolar polymer binder suitably may be completely free of such polar groups or may have no more than 10, 9, 8, 7, 6, 5, 4, 3, 2, 1 or 0.5 weight % of such groups present in the polymer based on total weight of the polymer. In certain aspects, a nonpolar polymer binder will have no more than 10, 9, 8, 7, 6, 5, 4, 3, 2, 1 or 0.5% of repeat that contain such polar groups based on total repeat units in the nonpolar polymer binder.

The term “lithium conductive particles” herein refers to particles included in the protective layer that facilitate lithium-ion and/or electronic transport.

In aspects, the term “substantially free of” herein refers to a composition that contains no intentionally added moieties, and in which any residual or trace content is below a threshold level (e.g., less than about 10, 9, 8, 7, 6, 5, 4, 3, 2, 1, 0.5 or 0.1 wt %) as may be specified in this disclosure.

The term “lithium secondary battery” herein refers to a rechargeable electrochemical cell that includes a lithium metal anode, a cathode, and an electrolyte capable of transporting lithium ions, wherein the battery is designed to undergo multiple charge-discharge cycles.

Unless otherwise defined, all terms including technical and scientific terms used herein have the same meanings as the meanings generally understood by one skilled in the art to which the present disclosure pertains. Terms, such as those defined in commonly used dictionaries, are to be interpreted as having meanings consistent with the relevant technical literature and the present disclosure and are not to be interpreted as having idealized or overly formal meanings unless expressly so defined herein.

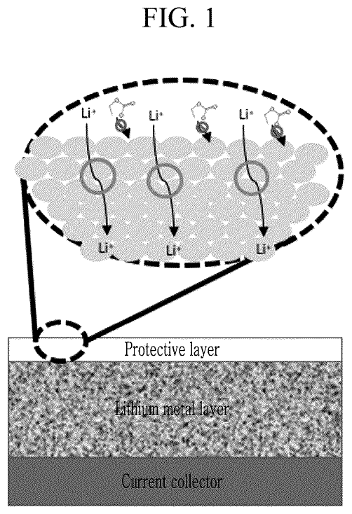

FIG. 1 is a schematic view of a lithium metal anode according to some embodiments of the present disclosure.

Referring to FIG. 1, a lithium metal anode according to some embodiments of the present disclosure may include a current collector, a lithium metal layer, and a protective layer. Specifically, the lithium metal anode of the present disclosure includes a protective layer on a lithium metal layer, which is formed by electrodepositing lithium onto a current collector through charging and serves as a negative electrode, and, when applied to a battery, can provide a lithium metal anode that blocks permeation of an electrolyte while simultaneously allowing for easy permeation of lithium ions.

The current collector is a negative electrode current collector on which the lithium metal layer is arranged and may be a member for electrical connection within a battery. The current collector is not particularly limited as long as it has conductivity without causing chemical changes in a lithium secondary battery. The current collector may be, by way of non-limiting examples, copper, stainless steel, aluminum, nickel, titanium, fired carbon, or copper or stainless-steel surface-treated with carbon, nickel, titanium, silver, or the like. Specifically, the current collector may include copper.

The current collector may have the form of a foil, but this is not a limiting example, and may be in the form of a mesh, foam, rod, wire, or sheet made by weaving wire. In some embodiments, the current collector may have a structure having fine irregularities formed on a surface.

The lithium metal layer may include a lithium metal or a lithium metal alloy. The lithium metal layer includes the lithium metal or the lithium metal alloy, thereby facilitating lithium electrodeposition during charging and discharging.

The lithium metal alloy may include an alloy of lithium and a metal or metalloid capable of alloying with lithium. The metal or metalloid capable of alloying with lithium may be, for example, a lithiophilic metal such as aluminum, zinc, gold, silver, magnesium, bismuth, cadmium, antimony, silicon, lead, tin, gallium, germanium, or indium.

The lithium metal layer may further include a lithium electrodeposition layer. Specifically, the lithium metal layer may include an initial lithium layer, and a lithium electrodeposition layer arranged on the initial lithium layer. The initial lithium layer may refer to rolled lithium arranged on the current collector to facilitate electrodeposition of lithium, and the lithium electrodeposition layer may be formed as lithium moves to the lithium metal layer when charge and discharge are performed at a battery terminal.

In some embodiments, a thickness of the lithium electrodeposition layer may be 5 to 20 μm. Specifically, the thickness may be 8 to 12 μm. As the lithium electrodeposition layer is formed within the thickness range, there is an advantage in that a battery with excellent electrochemical performance can be realized without collapse of the protective layer. If the thickness of the lithium electrodeposition layer falls outside the range, the protective layer may be damaged, leading to inflow of an electrolyte.

In some embodiments, an average thickness ratio of the initial lithium layer to the lithium electrodeposition layer (initial lithium layer thickness: lithium electrodeposition layer thickness) may be 5:5 to 20:20. Specifically, the average thickness ratio may be 20:8 to 20:15.

As the average thickness ratio falls within the range, it is possible to implement a negative electrode with improved electrochemical performance without damage to the protective layer. If the thickness of the initial lithium layer is excessively large in the average thickness ratio, there is a problem in that lithium electrodeposition is not performed properly, making it impossible to improve the electrochemical performance of the negative electrode. If the thickness of the lithium electrodeposition layer is excessively large in the average thickness ratio, there is a problem that lithium electrodeposition is performed excessively, causing damage to the protective layer.

The protective layer is arranged on the lithium metal layer and can block permeation of the electrolyte while simultaneously assisting easy permeation of lithium ions into the lithium metal layer. The protective layer may include a polymer binder and lithium conductive particles. Specifically, the protective layer may be implemented as a plurality of agglomerated composites of the polymer binder and the lithium conductive particles. More specifically, the agglomerated composites may have an average particle diameter (D50) of 0.4 to 0.6 μm.

The composites may have a spherical shape with a sphericity of 0.6 or more. The sphericity refers to a ratio of a short axis length to a long axis length on a cross-section of the composite. The composite has a spherical shape with the sphericity described above, so that the plurality of composites is filled in the protective layer, and lithium ions migrate along voids formed by interfaces of the composites.

In some embodiments, a packing density of the polymer binder and the lithium conductive particles in the protective layer may be 75% to 85% based on 100% of the protective layer. The packing density may refer to a density at which the polymer binder and the lithium conductive particles are filled in a space of the protective layer. As at least one composite including the polymer binder and the lithium conductive particles is filled within the range based on 100% of the protective layer, permeation of the electrolyte can be prevented, and the mobility of lithium ions can be improved.

When the packing density exceeds the upper limit of the range, there is a problem of lithium dendrite growth due to insufficient binder distribution. If the packing density falls below the lower limit of the range, there is a problem of capacity reduction due to high resistance.

The polymer binder may prevent penetration of the electrolyte in the protective layer and assist agglomeration of the lithium conductive particles. In some embodiments, the polymer binder may be a nonpolar material. As the polymer binder is composed of a non-polar material, reactions with a polar electrolyte can be minimized. If the protective layer has polarity, the electrolyte may permeate or swell the protective layer, reacting with the lithium surface. In contrast, by minimizing the reaction between the polymer binder and the electrolyte, the problem of cell life being reduced as the negative electrode is consumed can be prevented.

In some embodiments, the polymer binder may include at least one of a styrene-based polymer, a block co-polymer, a polyolefin-based polymer, a polyurethane-based polymer, and a silica-based polymer. The silica-based polymer may be, for example, PMMA. As the polymer binder includes the aforementioned material, permeation of the electrolyte can be prevented.

In some embodiments, the polymer binder may be a high-elasticity polymer. The high-elasticity polymer is a polymer with elasticity, which ensures that the protective layer is not damaged even if lithium electrodeposition occurs non-uniformly, thereby easily preventing permeation of the electrolyte. The high-elasticity polymer may be, for example, (SIS) polystyrene-block-polyisoprene-block-polystyrene.

In some embodiments, the polymer binder may not include fluorine (F). Specifically, if fluorine is included in the polymer binder, the fluorine may react with lithium and inhibit the mobility of lithium during charging and discharging, thereby deteriorating the electrochemical characteristics of the battery.

The lithium conductive particles may be particles that assist in penetration of lithium ions. Specifically, the lithium conductive particles can assist lithium ions in easily migrating between the negative electrode and the positive electrode in the battery during charging and discharging of the battery. More specifically, the lithium conductive particles can facilitate easy permeation of lithium ions in the protective layer.

In some embodiments, the lithium conductive particles may include at least one of, by way of non-limiting examples, a lithium-based oxide, a nitride, a sulfide, a fluoride, a phosphide, and a solid electrolyte material. The solid electrolyte material may include at least one of LLZO, LiPON, and S-glass. Specifically, the solid electrolyte material may be LLZO(Li₇La₃Zr₂O₁₂).

In some embodiments, the lithium conductive particles may include a doping material. The doping material may include at least one of Nb, Ta, and Ga. Specifically, the doping material may be a Nb-based material. As the lithium conductive particles include a doping material, the mobility of lithium ions permeating through the electrolyte can be improved.

In some embodiments, an average particle diameter (D50) of the lithium conductive particles may be 100 to 850 nm. The average particle diameter (D50) represents the particle size at which the cumulative percentage of the lithium conductive particles reaches 50%. The average particle diameter (D50) of the lithium conductive particles may be 400 to 600 nm. As the average particle diameter of the lithium conductive particles falls within the range, the packing density within the protective layer can be increased within a range that facilitates movement of lithium in combination with the polymer binder.

In some embodiments, the lithium conductive particles may include fine particles and coarse particles. Specifically, the fine particles and the coarse particles refer to particles having different average particle diameters (D50), and the coarse particles refer to particles having a larger average particle diameter (D50) compared to the fine particles.

In some embodiments, a weight ratio of the fine particles to the coarse particles in the lithium conductive particles (fine particles (wt %):coarse particles (wt %)) can satisfy 0.5:9.5 to 3.0:7.0. Specifically, the weight ratio can satisfy 0.5:9.5 to 1.5:8.5. As the lithium conductive particles include fine particles and coarse particles in the weight ratio described above, the packing density can be increased to facilitate migration of lithium ions.

If the weight ratio exceeds the upper limit of the range, there is a problem that the particle surface area increases and the binder distribution becomes non-uniform, leading to lithium dendrite growth. If the weight ratio falls below the lower limit of the range, there is a problem that the packing density decreases, leading to slowed lithium transfer.

In some embodiments, a weight ratio of the lithium conductive particles to the polymer binder in the protective layer (lithium conductive particles (wt %)/polymer binder (wt %)) may be 2.0 to 10.0. Specifically, the weight ratio can satisfy 2.3 to 9.0, more specifically 4.0 to 6.5. As the ratio falls within the range, the problem of charging being impossible due to overvoltage during charging of the battery can be prevented, and lithium can be uniformly electrodeposited under the protective layer to improve electrochemical characteristics.

If the ratio exceeds the upper limit of the range, there is a problem of lithium being electrodeposited on top of the protective film, leading to a short circuit. If the ratio falls below the lower limit of the range, there are problems in that pinholes occur, leading to localized lithium electrodeposition, which causes a short circuit, and early overvoltage occurs, making charging impossible.

In some embodiments, a thickness of the protective layer may be 10 to 20 μm. The thickness of the protective layer refers to a length in a vertical direction from an upper surface of the lithium metal layer and may specifically refer to a height of the protective layer. Specifically, the thickness of the protective layer may be 12.5 to 17.5 μm.

As the thickness of the above protective layer falls within the range, there is an advantage of excellent cycle life performance during charging and discharging of the battery. If the thickness of the protective layer falls outside the upper and lower limits of the range, there is a problem of inferior cycle life performance during charging and discharging of the battery.

In some embodiments, the protective layer may include a solvent. The solvent may serve to slurry the protective layer so as to arrange the protective layer on the lithium metal layer. Specifically, the solvent does not react with lithium and can partially dissolve the polymer binder in the protective layer to assist the polymer binder in agglomerating with the lithium conductive particles.

In some embodiments, the solvent may include at least one of benzene, toluene, xylene, and an alkane-based material. Specifically, the alkane-based material may include butane, propane, pentane, and the like. The solvent may be a material capable of easily mixing the polymer binder and the lithium conductive particles and dissolving at least a portion of the polymer binder.

In some embodiments, the solvent may include 30 to 50 wt % of solid content based on 100 wt % of the protective layer. Specifically, the solvent may include 35 to 45 wt % of solid content based on 100 wt % of the protective layer. The solvent may be included in the lithium metal anode in the form of solid content within the range. As the solvent is included in the lithium metal anode product within the range, the polymer binder and lithium conductive particles can be structurally stably arranged.

In some embodiments, the protective layer may further include a dispersant. The dispersant can assist the polymer binder and the lithium conductive particles in dispersing easily within the protective layer. Specifically, the dispersant may be, for example, polyvinylpyrrolidone (PVP).

In some embodiments, the dispersant may be included in an amount of 3 wt % or less based on 100 wt % of the protective layer. Specifically, the dispersant may be included in an amount of 0.1 to 2.0 wt %, more specifically, 0.5 to 1.5 wt %, based on 100 wt % of the protective layer. As the dispersant is included within the range, the protective layer is uniformly applied and arranged on the lithium metal layer, and the polymer binder and the lithium conductive particles can be easily dispersed.

If the dispersant exceeds the upper limit of the range, there is a problem in that the content of the dispersant becomes excessively large, while the contents of the polymer binder and lithium conductive particles decrease, leading to reductions in the strength of the protective layer and the electrochemical characteristics of the negative electrode. If the dispersant falls below the lower limit of the range, there is a problem in that the content of the dispersant is excessively low, resulting in insufficient effects of the dispersant.

According to some embodiments of the present disclosure, a lithium secondary battery may include a positive electrode and a negative electrode. Specifically, the lithium secondary battery may include a positive electrode, a negative electrode positioned opposite the positive electrode, a separator interposed between the positive electrode and the negative electrode, and an electrolyte. For the negative electrode, the explanatory contents of the lithium metal anode of the present disclosure described above can be considered within a range that does not contradict them.

In addition, the lithium secondary battery may optionally further include a battery container that accommodates an electrode assembly of the positive electrode, the negative electrode, and the separator, and a sealing member that seals the battery container.

The positive electrode may include a positive electrode current collector, and a positive electrode active material layer arranged on the positive electrode current collector, and the positive electrode active material layer may include a positive electrode active material.

The positive electrode current collector is not particularly limited as long as it has conductivity without causing a chemical change in the battery. For example, stainless steel, aluminum, nickel, titanium, fired carbon, aluminum or stainless steel each surface-treated with carbon, nickel, titanium, silver, or the like, or the like may be used.

In some embodiments, the positive electrode current collector may typically have a thickness of 3 to 500 μm, and fine irregularities may be formed on a surface of the positive electrode current collector to increase the adhesion of the positive electrode active material. For example, the positive electrode current collector may be used in various forms such as a film, a sheet, a foil, a net, a porous body, a foamed body, and a non-woven fabric body.

As the positive electrode active material, a compound capable of reversibly intercalating and deintercalating lithium (lithiated intercalation compound) may be used. Specifically, one or more complex oxides of lithium and a metal selected from cobalt, manganese, nickel, and combinations thereof may be used, and specific examples thereof may include a compound represented by one of the following chemical formulas.

LiₐA_{1-b}B_{b}D₂ (in the formula, 0.90≤a≤1.8, and 0≤b≤0.5); LiₐE_{1-b}B_{b}O_{2-c}D_{c} (in the formula, 0.90≤a≤1.8, 0≤b≤0.5, 0≤c≤0.05); LiE_{2-b}B_{b}O_{4-c}D_{c} (in the formula, 0≤b≤0.5, 0≤c≤0.05); LiₐNi_{1-b-c}Co_{b}B_{c}D_{α} (in the formula, 0.90≤a≤1.8, 0≤b≤0.5, 0≤c≤0.05, 0<α≤2); LiₐNi_{1-b-c}Co_{b}B_{c}O_{2-α}T_{α} (in the formula, 0.90≤a≤1.8, 0≤b≤0.5, 0≤c≤0.05, 0<α<2); LiₐNi_{1-b-c}Co_{b}B_{c}O_{2-α}T₂ (in the formula, 0.90≤a≤1.8, 0≤b≤0.5, 0≤c≤0.05, 0<α<2); LiₐNi_{1-b-c}Mn_{b}B_{c}D_{α} (in the formula, 0.90≤a≤1.8, 0≤b≤0.5, 0≤c≤0.05, 0<α≤2); LiₐNi_{1-b-c}Mn_{b}B_{c}O_{2-α}T_{α} (in the formula, 0.90≤a≤1.8, 0≤b≤0.5, 0≤c≤0.05, 0<α<2); LiₐNi_{1-b-c}Mn_{b}B_{c}O_{2- α}T₂ (in the formula, 0.90≤a≤1.8, 0≤b≤0.5, 0≤c≤0.05, 0<α<2); LiₐNi_{b}E_{c}G_{d}O₂ (in the formula, 0.90≤a≤1.8, 0≤b≤0.9, 0≤c≤0.5, 0.001≤d≤0.1); LiₐNi_{b}Co_{c}Mn_{d}GₑO₂ (in the formula, 0.90≤a≤1.8, 0≤b≤0.9, 0≤c≤0.5, 0≤d≤0.5, 0.001≤e≤0.1); LiₐNiG_{b}O₂ (in the formula, 0.90≤a≤1.8, 0.001≤b≤0.1); LiₐCoG_{b}O₂ (in the formula, 0.90≤a≤1.8, 0.001≤b≤0.1); LiₐMnG_{b}O₂ (in the formula, 0.90≤a≤1.8, 0.001≤b≤0.1); LiₐMn₂G_{b}O₄ (in the formula, 0.90≤a≤1.8, 0.001≤b≤0.1); QO₂; QS₂; LiQS₂; V₂O₅; LiV₂O₅; LiIO₂; LiNiVO₄; Li_{(3-f)}J₂PO₄₃ (0≤f≤2); Li_{(3-f)}Fe₂ PO₄₃ (0≤f≤2); and LiFePO₄

In the chemical formulas, A may be Ni, Co, Mn, or a combination thereof; B may be Al, Ni, Co, Mn, Cr, Fe, Mg, Sr, V, a rare earth element, or a combination thereof; D may be O, F, S, P, or a combination thereof; E may be Co, Mn, or a combination thereof; T is F, S, P, or a combination thereof; G may be Al, Cr, Mn, Fe, Mg, La, Ce, Sr, V, or a combination thereof; Q may be Ti, Mo, Mn, or a combination thereof; I may be Cr, V, Fe, Sc, Y, or a combination thereof; and J may be V, Cr, Mn, Co, Ni, Cu, or a combination thereof.

In other embodiments, one that has a coating layer on the surface of the compound, or a mixture of the compound and a compound having a coating layer may be used. The coating layer may include at least one coating element compound selected from the group consisting of an oxide of a coating element, a hydroxide of a coating element, an oxyhydroxide of a coating element, an oxycarbonate of a coating element, and a hydroxycarbonate of a coating element.

In some embodiments, the compound forming the coating layer may be amorphous or crystalline. For the coating element included in the above coating layer, Mg, Al, Co, K, Na, Ca, Si, Ti, V, Sn, Ge, Ga, B, As, Zr, or a mixture thereof may be used. The coating layer forming process may adopt any coating method (e.g., spray coating, dipping, etc.) as long as it can coat the compound with these elements without adversely affecting the physical properties of the positive electrode active material. Since the process is well understood by one skilled in the relevant field, a detailed description thereof will be omitted.

The positive electrode active material layer may further include a binder and/or a conductive material together with the positive electrode active material. The binder serves to improve the adhesion between positive electrode active material particles and the adhesion between the positive electrode active material and the positive electrode current collector. Specific examples include, but are not limited to, polyvinylidene fluoride (PVDF), vinylidene fluoride-hexafluoropropylene copolymer (PVDF-co-HFP), polyvinyl alcohol, polyacrylonitrile, carboxymethyl cellulose (CMC), starch, hydroxypropyl cellulose, regenerated cellulose, polyvinyl pyrrolidone, polytetrafluoroethylene, polyethylene, polypropylene, ethylene-propylene-diene monomer rubber (EPDM rubber), sulfonated-EPDM, styrene butadiene rubber (SBR), fluoro rubber, or various copolymers thereof, and the like, and one thereof may be used alone or a mixture of two or more thereof may be used. The binder may be included in an amount of 1 to 30 wt % based on the total weight of the positive electrode active material layer.

The conductive material is used to impart conductivity to the electrode and can be used without particular limitation as long as it has electronic conductivity without causing a chemical change in a battery to be configured. Specific examples may include, but are not limited to, graphite such as natural graphite and artificial graphite; a carbon-based material such as carbon black, acetylene black, Ketjen black, channel black, furnace black, lamp black, thermal black, and carbon fiber; metal powders or metal fibers such as copper, nickel, aluminum, and silver; a conductive whisker such as zinc oxide and potassium titanate; a conductive metal oxide such as titanium oxide; or a conductive polymer such as polyphenylene derivative, or the like, and one thereof may be used alone or a mixture of two or more thereof may be used. The conductive material may typically be included in an amount of 1 to 30 wt % based on the total weight of the positive electrode active material layer.

The positive electrode may be manufactured according to a positive electrode manufacturing method of the related art. Specifically, the positive electrode may be manufactured by applying a composition for forming a positive electrode active material layer, which includes a positive electrode active material and optionally, as necessary, a binder, a conductive material or a solvent, onto a positive electrode current collector, followed by drying and rolling. In this case, the types and contents of the positive electrode active material, binder, and conductive material are as described above.

The solvent may be a solvent that is generally used in the relevant technical field, and may include dimethylsulfoxide (DMSO), isopropyl alcohol, N-methylpyrrolidone (NMP), acetone, or water, and one of these may be used alone, or a mixture of two or more may be used. An amount of the solvent used is sufficient to dissolve or disperse the positive electrode active material, conductive material, and binder, considering the coating thickness of the slurry and the manufacturing yield, while achieving a viscosity that ensures excellent thickness uniformity during the application process for manufacturing the positive electrode.

In other embodiments, the positive electrode may be manufactured by casting the composition for forming a positive electrode active material layer onto a separate support, and then laminating a film obtained by delaminating it from the support onto a positive electrode current collector.

The separator serves to separate the positive electrode and the negative electrode and to provide a migration path for lithium ions, in which any separator may be used as the separator without particular limitation as long as it is typically used as a separator in a secondary battery, and particularly, a separator having high moisture-retention ability for an electrolyte solution as well as a low resistance to the migration of electrolyte ions may be preferably used. Specifically, a porous polymer film, for example, a porous polymer film manufactured from a polyolefin-based polymer, such as an ethylene homopolymer, a propylene homopolymer, an ethylene/butene copolymer, an ethylene/hexene copolymer, and an ethylene/methacrylate copolymer, or a stacked structure having two or more layers thereof may be used. In addition, a usual porous non-woven fabric, for example, a non-woven fabric made of high melting point glass fibers, polyethylene terephthalate fibers, or the like may be used. In other embodiments, the separator may be a coated separator including a ceramic component or a polymer material to secure heat resistance or mechanical strength and may optionally be used in a single-layer or multi-layer structure.

For the electrolyte, an impregnation electrolyte for forming the gel polymer electrolyte described above may be used. One or more additives, for example, a haloalkylene carbonate-based compound such as difluoroethylene carbonate, pyridine, triethylphosphite, triethanolamine, cyclic ether, ethylenediamine, n-glyme, hexamethylphosphoric acid triamide, a nitrobenzene derivative, sulfur, a quinone imine dye, N-substituted oxazolidinone, N,N-substituted imidazolidine, ethylene glycol dialkyl ether, an ammonium salt, pyrrole, 2-methoxy ethanol, or aluminum trichloride, may be further included in the electrolyte for the purpose of improving life characteristics of the battery, suppressing a decrease in battery capacity, improving discharge capacity of the battery, and the like, in addition to the above-described electrolyte components. In this case, the additive may be included in an amount of 0.1 to 5 wt % based on the total weight of the electrolyte.

Below, preferred Examples of the present disclosure and Comparative Examples will be described. However, the following Examples are only preferred examples of the present disclosure, and the present disclosure is not limited to the following Examples.

### EXPERIMENTAL EXAMPLE

### Preparation of Lithium Metal Anode

### Example 1

### Preparation of Current Collector

A copper foil current collector was prepared for use in the negative electrode for a lithium secondary battery of the present disclosure. In this case, the thickness of the copper foil current collector used was 10 μm.

### Formation of Lithium Metal Layer

A lithium metal layer was formed on the current collector by a coating method using a rolling device. In this case, the lithium metal layer was formed with lithium metal at a thickness of 20 μm.

### Formation of Protective Layer

To arrange a protective layer on the lithium metal layer, a protective layer slurry was prepared. The protective layer slurry was prepared by mixing a binder, lithium conductive particles, and a solvent. Specifically, the protective layer slurry used SIS (Polystyrene-block-polyisprene-block-polystyrene) being a nonpolar polymer, as the binder, NbLLZO(Li₇La₃Zr₂O₁₂) as the lithium conductive particles, and toluene as the solvent. In this case, the protective layer slurry was composed of 6.3 wt % of binder, 25.3 wt % of lithium conductive particles, and 68.4 wt % of solvent based on 100 wt % of slurry, and the weight ratio of the lithium conductive particles to the binder in the protective layer slurry (lithium conductive particles (wt %)/binder (wt %)) was about 4.0.

For the lithium conductive particles, particles with an average particle diameter (D50) of 500 nm and Nb doped at 5 wt % based on 100 wt % of lithium conductive particles were used.

Subsequently, the protective layer slurry was directly coated on the lithium metal layer at a thickness of 15 μm by a doctor blade method using a semi-automatic coating device.

Subsequently, the protective layer slurry coated on the lithium metal layer was dried at a temperature of 80° C. for 90 minutes in a vacuum oven device.

### Comparative Example 1

In the preparation of a lithium metal anode, the same procedure as in Example 1 was performed, except that the step of coating a protective layer on a lithium metal layer was not included at all.

### Control of Ratio of Binder and Lithium Conductive Particles

### Example 2

In the preparation of a lithium metal anode, the same procedure as in Example 1 was performed, except that the weight ratio of the lithium conductive particles to the binder in the protective layer slurry (lithium conductive particles (weight %)/binder (weight %)) in the protective layer formation step was changed to about 9. Specifically, the same procedure as in Example 1 was performed, except that the weight ratio of the lithium conductive particles to the binder (lithium conductive particles (weight %):binder (weight %)) was 9:1.

### Example 3

In the preparation of a lithium metal anode, the same procedure as in Example 1 was performed, except that the weight ratio of the lithium conductive particles to the binder in the protective layer slurry (lithium conductive particles (weight %)/binder (weight %)) in the protective layer formation step was changed to about 2.3. Specifically, the same procedure as in Example 1 was performed, except that the weight ratio of the lithium conductive particles to the binder (lithium conductive particles (weight %):binder (weight %)) was 7:3.

### Comparative Example 2

In the preparation of a lithium metal anode, the same procedure as in Example 1 was performed, except that the weight ratio of the lithium conductive particles to the binder in the protective layer slurry (lithium conductive particles (weight %)/binder (weight %)) in the protective layer formation step was changed to about 1.5. Specifically, the same procedure as in Example 1 was performed, except that the weight ratio of the lithium conductive particles to the binder (lithium conductive particles (weight %):binder (weight %)) was 6:4.

### comparative Example 3

In the preparation of a lithium metal anode, the same procedure as in Example 1 was performed, except that the weight ratio of the lithium conductive particles to the binder in the protective layer slurry (lithium conductive particles (weight %)/binder (weight %)) in the protective layer formation step was changed to about 1. Specifically, the same procedure as in Example 1 was performed, except that the weight ratio of the lithium conductive particles to the binder (lithium conductive particles (weight %):binder (weight %)) was 5:5.

### Control of Thickness of Protective Layer

### Example 4

In the preparation of a lithium metal anode, the same procedure as in Example 1 was performed, except that the thickness of the protective layer was controlled to 20 μm in the protective layer formation step.

### Example 5

In the preparation of a lithium metal anode, the same procedure as in Example 1 was performed, except that the thickness of the protective layer was controlled to 10μm in the protective layer formation step.

### Comparative Example 4

In the preparation of a lithium metal anode, the same procedure as in Example 1 was performed, except that the thickness of the protective layer was controlled to 5 μm in the protective layer formation step.

### Preparation of Lithium Secondary Battery

A positive electrode slurry was prepared by adding a positive electrode active material (LiNi_{0.9}Co_{0.05}Mn_{0.05}O₂), a conductive material (carbon nanotubes), and a binder (polyvinylidene fluoride) to the solvent NMP in a weight ratio of 8:1:1. A positive electrode was prepared by applying the positive electrode slurry was applied to one surface of a positive electrode current collector (Al thin film) with a thickness of 20 μm, followed by drying and roll pressing. In this case, the positive electrode active material was loaded in an amount of 20.4 mg/cm².

The positive electrode was arranged on an aluminum foil with a thickness of 12 μm. Subsequently, the positive electrode and the lithium metal anodes each prepared according to the examples of the present disclosure and the comparative examples were positioned to face each other, a 12 μm polyethylene separator having a 2 μm alumina coating layer was interposed between the positive electrode and the negative electrode, and then a non-aqueous electrolyte was injected, resulting in a secondary battery.

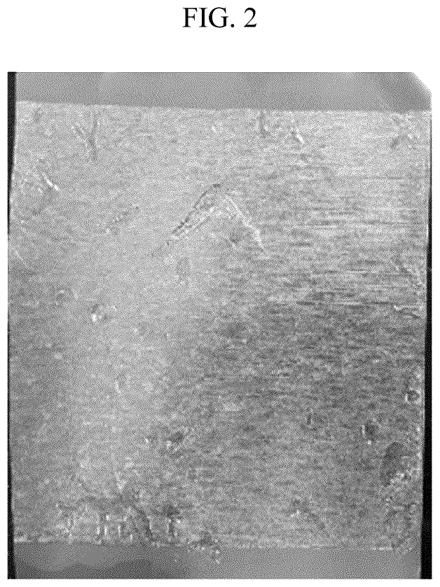

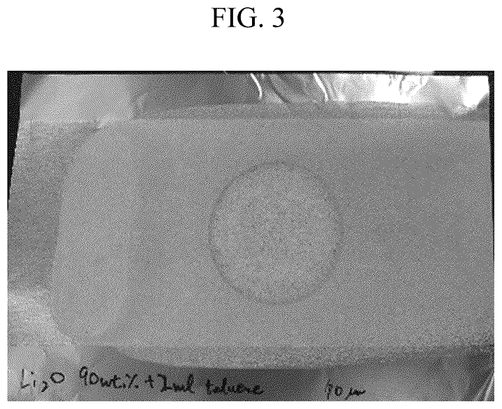

FIGS. 2 and 3 are plan views of lithium metal anodes according to an Example of the present disclosure and a Comparative Example.

FIG. 2 is a view confirming whether a reaction occurred when ethanol was supplied onto the protective layer of the lithium metal anode prepared according to Example 1, while FIG. 3 shows the same for Comparative Example 1. Referring to FIG. 2, it can be confirmed that the lithium metal anode prepared according to Example 1 remains stable when a solution, such as ethanol, which forms an electrolyte, is supplied on the protective layer, as the ethanol does not permeate and does not react. Referring to FIG. 3, it can be confirmed that the lithium metal anode prepared according to Comparative Example 1, which does not include a protective layer, has a high reactivity with a polar solution, and thus reacts with a polar substance such as ethanol, which forms the electrolyte, leading to oxidation. With this, it can be confirmed that, if a protective layer is not included, there is a problem in which the lithium metal reacts with the electrolyte, resulting in a reduction in the life of the negative electrode.

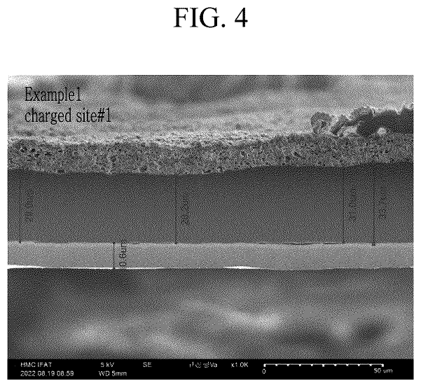

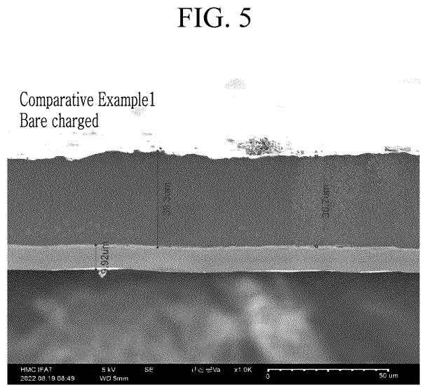

FIGS. 4 and 5 are cross-sectional views of lithium metal anodes according to the Example of the present disclosure and the Comparative Example.

FIGS. 4 and 5 show the results of lithium electrodeposition cross-sections of the lithium metal anodes according to Example 1 and Comparative Example 1, respectively. In Example 1 where the lithium metal anode is coated with a protective layer, it was confirmed that lithium was electrodeposited to a thickness of about 10 μm when electrodeposited onto existing lithium with a thickness of 20 μm. In Comparative Example 1, it was confirmed that lithium was electrodeposited to a thickness of about 18 μm when electrodeposited onto existing lithium with a thickness of 20 μm.

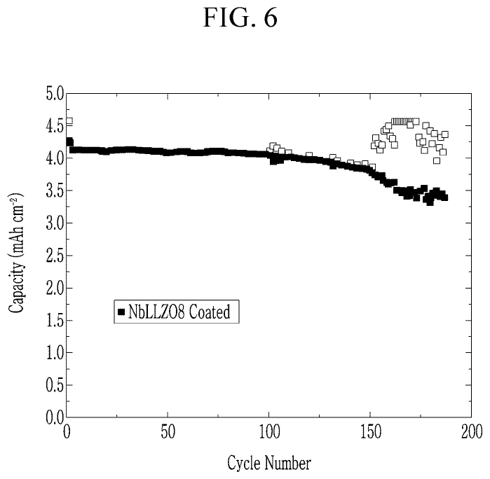

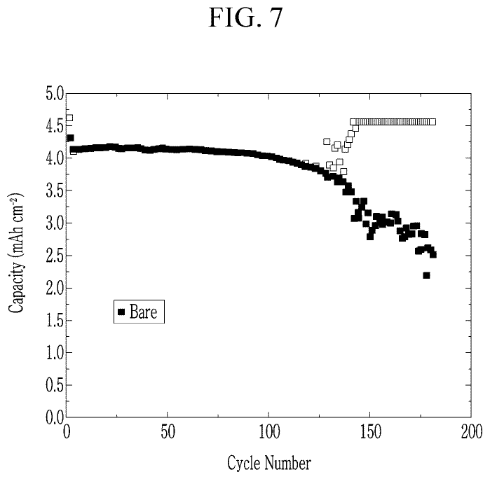

FIGS. 6 and 7 are graphs showing life characteristics of lithium metal anodes according to the Example of the present disclosure and the Comparative Example.

FIGS. 6 and 7 show the life characteristics of the lithium metal anodes according to Example 1 and Comparative Example 1. It can be confirmed that Example 1 has a life cycle of about 152 cycles, while Comparative Example 1 has a life cycle of about 133 cycles, indicating that the life characteristics of the lithium metal anode including the protective layer are superior.

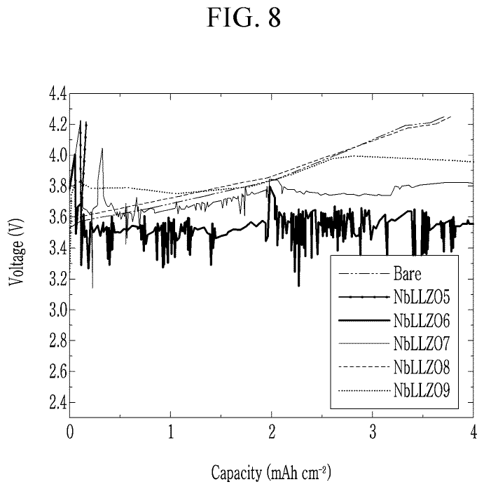

FIG. 8 shows a graph of charging voltage versus capacity according to Examples of the present disclosure and Comparative Examples.

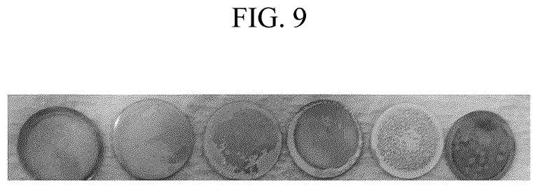

FIG. 9 is a plan view showing surfaces of lithium metal anodes after full charging according to Examples of the present disclosure and Comparative Examples.

FIG. 8 is a graph showing the single full charge voltage profile of the lithium metal anodes prepared according to Comparative Example 1 (Bare), Comparative Example 2 (NbLLZO5), Comparative Example 3 (NbLLZO6), Example 1 (NbLLZO8), Example 2 (NbLLZO9), and Example 3 (NbLLZO7) of the present disclosure. Specifically, to obtain the full charge voltage profile, the voltage was cut-off to 4.25 V with a C/10 constant current charge rate, and the value of the charge voltage relative to the capacity was plotted in a graph. FIG. 9 is a plan view of the surfaces of the lithium negative electrodes after full charging, presented in order from the left for Comparative Example 1, Comparative Example 3, Comparative Example 2, Example 3, Example 1, and Example 2.

Upon reviewing FIGS. 8 and 9, it was confirmed that, in Comparative Example 1 where a protective layer was not formed at all, the reference charging voltage profile is exhibited, and in Example 1 including a protective layer, the overpotential increased compared to Comparative Example 1, but full charging was successful, and lithium was electrodeposited under the protective film. In addition, comparing Examples 1 to 3 with Comparative Examples 2 and 4, it was confirmed that Examples 1 to 3 had superior charging voltage values compared to Comparative Examples 2 and 4.

It can be confirmed that in Comparative Example 2, charging is impossible due to early overvoltage and short circuit, and lithium is locally electrodeposited through pinholes, leading to short circuits. It can be confirmed that in Comparative Example 3, charging is impossible due to early overvoltage and short circuit, and lithium is locally electrodeposited through pinholes, leading to short circuits.

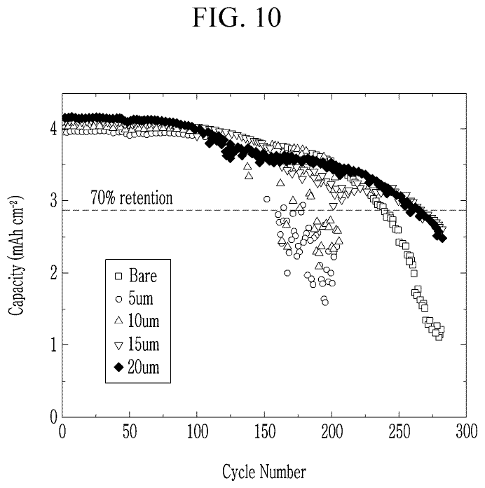

FIG. 10 shows a graph of capacity versus cycle number according to Examples of the present disclosure and Comparative Examples.

The cycle experiment conditions of FIG. 10 were measured using the following method for Comparative Example 1 (Bare), Comparative Example 4 (5 μm), Example 1 (15 μm), Example 4 (20 μm), and Example 5 (10 μm).

For the formation conditions, i) voltage cut-off to 4.25 V with C/10 constant current charge rate, ii) waiting for 10 minutes, iii) voltage cut-off to 3.0 V with C/10 constant current charge rate, iv) waiting for 10 minutes were performed in this order. For the C/3-C/3 cycle conditions, i) voltage was maintained at 4.25 V until C/20 current cut-off with C/3 constant current charge rate, ii) waiting for 10 minutes, iii) voltage cut-off to 3.0 V with C/3 constant current discharge rate, iv) waiting for 10 minutes, v) i) to iv) were repeated.

Referring to FIG. 10, it was confirmed that Comparative Example 1 had about 240 cycles, Comparative Example 4 had about 160 cycles, Example 1 had about 268 cycles, Example 4 had about 264 cycles, and Example 5 had about 186 cycles. As such, it was confirmed that when the protective film thickness is excessively small, there is a problem that the cycle life is reduced, leading to premature short circuits. In addition, upon examining Examples 1, 4, and 5, it can be confirmed that the cycle life is significantly excellent within the range of about 15 μm to 20 μm as the optimal thickness of the protective film.

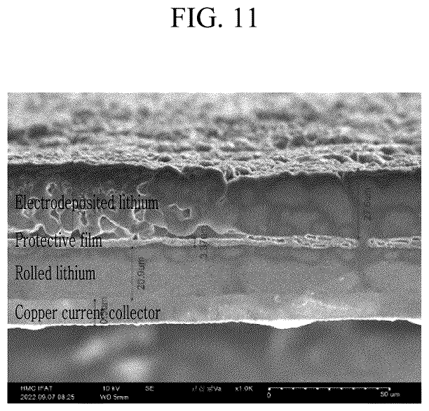

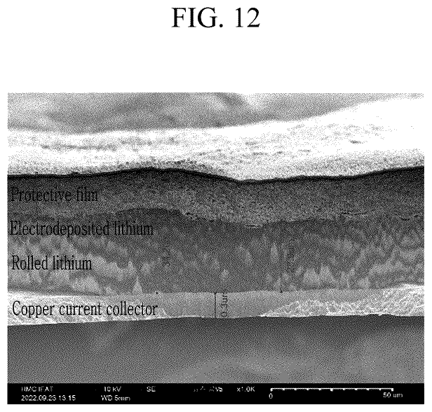

FIGS. 11 and 12 are cross-sectional views of lithium metal anodes according to the Example of the present disclosure and the Comparative Example.

FIGS. 11 and 12 show cross-sections of the lithium metal anodes after full charging according to Example 1 and Comparative Example 4, respectively. In Example 1, it was confirmed that the current collector, rolled lithium, electrodeposited lithium, and protective film were sequentially arranged in the lithium metal anode after full charging. However, in Comparative Example 4, it was confirmed that the current collector, rolled lithium, protective film, and electrodeposited lithium were sequentially arranged in the lithium metal anode after full charging, indicating a problem in that lithium is electrodeposited on top of the protective film. Accordingly, it can be confirmed that a lithium metal anode, in which lithium is stably electrodeposited only when the thickness of the protective film satisfies 10 μm or greater, specifically, 15 μm or greater, can be prepared.

It will be understood by one skilled in the art to which the present disclosure belongs that the present disclosure is not limited to the above embodiments, but can be manufactured in a variety of different forms, and can be implemented in other specific forms without changing the technical spirit or essential features of the present disclosure. Therefore, the embodiments described above should be understood as illustrative in all respects and not for purposes of limitation.

What is claimed is:

1. A lithium metal anode comprising:
a lithium metal layer disposed on a current collector; and
a protective layer disposed on the lithium metal layer,
wherein the protective layer comprises a polymer binder and lithium conductive particles, and
wherein the polymer binder is nonpolar.

2. The lithium metal anode of claim 1, wherein:
a weight ratio of the lithium conductive particles to the polymer binder (lithium conductive particles (wt %)/polymer binder (wt %)) is about 2.0 to 10.0.

3. The lithium metal anode of claim 1, wherein:
a thickness of the protective layer is about 10 to 20 μm.

4. The lithium metal anode of claim 1, wherein:
an average particle diameter (D50) of the lithium conductive particles is about 100 to nm.

5. The lithium metal anode of claim 1, wherein:
the polymer binder is polystyrene-block-polyisoprene-block-polystyrene (SIS).

6. The lithium metal anode of claim 1, wherein:
the polymer binder does not comprise fluorine (F).

7. The lithium metal anode of claim 1, wherein:
the polymer binder comprises at least one of a styrene-based polymer, a block co-polymer, a polyolefin-based polymer, a polyurethane-based polymer, and a silica-based polymer.

8. The lithium metal anode of claim 1, wherein:
the lithium conductive particles comprise at least one of a lithium-based oxide, a nitride, a sulfide, a fluoride, a phosphide, and a solid electrolyte material.

9. The lithium metal anode of claim 1, wherein:
the protective layer comprises a solvent, and
the solvent comprises about 30 to 50 wt % of solid content based on 100 wt % of the protective layer.

10. The lithium metal anode of claim 9, wherein:
the solvent comprises at least one of benzene, toluene, xylene, and an alkane-based material.

11. The lithium metal anode of claim 1, wherein:
the protective layer further comprises a dispersant, and
the dispersant is included in an amount of about 3 wt % or less based on 100 wt % of the protective layer.

12. The lithium metal anode of claim 1, wherein:
the lithium conductive particles comprise a doping material, and
the doping material is a Nb-based material.

13. The lithium metal anode of claim 1, wherein:
a packing density of the polymer binder and the lithium conductive particles in the protective layer is about 75 to 85% based on 100% of the protective layer.

14. The lithium metal anode of claim 1, wherein:
the lithium conductive particles comprise fine particles and coarse particles with an average particle diameter larger than that of the fine particles, and
a weight ratio of the fine particles to the coarse particles (fine particles (wt %):coarse particles (wt %)) is about 0.5:9.5 to 3.0:7.0.

15. The lithium metal anode of claim 1, further comprising
a lithium electrodeposition layer in the lithium metal layer, wherein
a thickness of the lithium electrodeposition layer is about 5 to 15 μm.

16. The lithium metal anode of claim 1, wherein:
the lithium metal layer further comprises an initial lithium layer and a lithium electrodeposition layer disposed on the initial lithium layer, and
an average thickness ratio of the initial lithium layer to the lithium electrodeposition layer (initial lithium layer: lithium electrodeposition layer) is about 5:5 to 20:20.

17. A lithium secondary battery comprising the lithium metal anode according to claim 1.

18. A lithium metal anode comprising:
a lithium metal layer disposed on a current collector; and
a protective layer disposed on the lithium metal layer,
wherein the protective layer comprises a polymer binder and lithium conductive particles,
wherein the polymer binder is nonpolar and does not comprise fluorine (F), and
wherein a lithium electrodeposition layer in the lithium metal layer has a thickness of about 15 μm or greater.

19. A lithium metal anode comprising:
a lithium metal layer disposed on a current collector; and
a protective layer disposed on the lithium metal layer,
wherein the protective layer comprises a polymer binder and lithium conductive particles,
wherein the polymer binder is nonpolar and does not comprise fluorine (F), and
wherein a weight ratio of the lithium conductive particles to the polymer binder (lithium conductive particles (wt %)/polymer binder (wt %)) is about 2.0 to 10.0.

20. The lithium metal anode of claim 19, wherein the lithium conductive particles are NbLLZO8, and the polymer binder is polystyrene-block-polyisoprene-block-polystyrene (SIS).
